(19) United States
(12) Patent Application Publication
(10) Pub. No.: US 2012/0062725 A1
(43) Pub. Date: Mar. 15, 2012

(54) SYSTEM FOR ERROR-PROOFING MANUAL ASSEMBLY OPERATIONS USING MACHINE VISION

(75) Inventors: Charles W. Wampler, II, Birmingham, MI (US); James W. Wells, Rochester Hills, MI (US); Roland J. Menassa, Macomb, MI (US)

(73) Assignee: GM GLOBAL TECHNOLOGY OPERATIONS, INC., DETROIT, MI (US)

(21) Appl. No.: 12/879,656

(22) Filed: Sep. 10, 2010

(51) Int. Cl. H04N 7/18; G08B 21/00

(52) U.S. Cl. 348/86; 340/540; 348/E07.085

(57) ABSTRACT

An error detection vision system that determines whether a proper part has been selected from a presentation device during an assembly process. In one embodiment, the presentation device is a rack including a plurality of bins, where the bins hold a plurality of different parts. The vision system includes one or more projecting devices that project a light beam towards the presentation device and a detector, such as a camera, receiving reflections back from a worker as he selects parts from the presentation device. The error detection vision system can employ various detection processes, such as a stereo pair of video cameras, vision using structured-light triangulation and infrared time-of-flight distance measurements.

### BACKGROUND OF THE INVENTION

1. Field of the Invention

This invention relates generally to a sensing system using vision technologies and, more particularly, to an error detection system that uses three-dimensional real-time machine vision, such as stereo vision, vision using structured-light triangulation or infrared time-of-flight distance measurements, for determining whether a worker has selected a proper part from a presentation device, such as a rack including a plurality of bins, during an assembly process.

2. Discussion of the Related Art

For certain automated assembly processes, such as various vehicle assembly processes, a worker is required to select parts from a rack, bin or other presentation device. In many occasions, a rack may include a plurality of bins holding several different parts from which the worker must choose. For example, in a process for assembling a seat belt assembly in a vehicle, the seat belts and seat belt retractors may be held in racks having several bins, where each bin includes a particular retractor or seat belt color for a particular vehicle. The worker must select the proper part from the bin so that it is accurately placed on the vehicle. An improperly selected and assembled part may be a critical part, and may require a vehicle recall as a result of the improperly assembled part.

It is known in the art to electronically determine that a correct part has been installed for a particular assembly process, and to warn the worker if a wrong part has been selected so that the correct part can be substituted. In one currently known process, the various parts are placed in bins that are positioned within certain areas of a rack. Light sensors are placed at an opening to each bin, where a beam of light is broken as the vehicle operator places his hand in the bin to retrieve the part. A processing system determines which sensor light has been tripped, and determines whether the part associated with that bin is the proper one for the vehicle currently being detected at the assembly location. A signal light can be provided as an indication of whether the worker has selected the proper part, such as a green light, or whether the worker has selected the wrong part, such as a red light. Additionally, a light can be included that provides a visual indication to the vehicle operator which bin to select the part from.

The known system described above for determining whether a worker has selected the proper part during an assembly process has a number of drawbacks. For example, the system is fairly complex, and is hard-wired to the rack and the vehicle assembly location. Thus, a number of wires are provided for the sensing system in the work area and to the location where the vehicle is being assembled. These wires and other devices are obstructions to the worker, and it requires a significant amount of work to disassembled and reassemble the sensing system when it is being moved from one location to another location.

### SUMMARY OF THE INVENTION

In accordance with the teachings of the present invention, an error detection vision system is disclosed that that determines whether a proper part has been selected from a presentation device during an assembly process. In one embodiment, the presentation device is a rack including a plurality of bins, where the bins hold a plurality of different parts. The vision system includes one or more projecting devices that project a light beam towards the presentation device and a detector, such as a camera, receiving reflections back from a worker as he selects parts from the presentation device. The error detection vision system can employ various detection processes, such as a stereo pair of video cameras, vision using structured-light triangulation and infrared time-of-flight distance measurements.

Additional features of the present invention will become apparent from the following description and appended claims taken in conjunction with the accompanying drawings.

### BRIEF DESCRIPTION OF THE DRAWINGS

FIG. 1 is a plan view of an error detection vision system for an assembly process that employs a stereo pair of video cameras, according to an embodiment of the present invention;

FIG. 2 is a plan view of an error detection vision system for an assembly process that employs a structured-light configuration, according to another embodiment of the present invention; and

FIG. 3 is a plan view of an error detection vision system for an assembly process that employs a time-of-flight configuration, according to another embodiment of the present invention.

### DETAILED DESCRIPTION OF THE EMBODIMENTS

The following discussion of the embodiments of the invention directed to an error detection vision system for determining whether a correct part has been selected to be installed on an assembly is merely exemplary in nature, and is in no way intended to limit the invention or its applications or uses. For example, the present invention has particular application for a vehicle assembly line. However, as will be appreciated by those skilled in the art, the sensing system of the invention will have application for other assembly processes.

The proposed invention includes a sensing system employing three-dimensional real-time machine vision using one or more stereo vision, vision using structured-light triangulation and infrared time-of-flight distance measurements to detect which one of multiple locations a worker has selected a part from. The invention also may include a part holding device, a display sub-system for indicating to the worker which part should be picked, and a computer control unit for coordinating the sensing and display with the progression of work pieces through the assembly station and for communicating with other assembly line control devices to record proper actions or flag errors.

The present invention also includes a method for using the control unit and the sensing system to quickly learn the association between locations in the rack and the identity of parts. This makes it simple to deploy the system to work with a wide variety of racks and a variety of arrangements of parts on the rack.

In the discussion below, the term “part pick-up zone” refers to the volume just in front of a part in or on a presentation rack or a volume through which the worker must reach to remove a part from a bin or the like. In applying the invention, several such zones will be defined and a part available in each zone is made known to the sensing system.

The present invention proposes three approaches to sensing which part a worker selects from a part presentation device, such as a rack. In the first approach, a stereo pair of video cameras is provided so that the stereo field-of-view covers the entire rack and an approach volume in front of the rack. By using known stereo machine vision techniques, the system senses the location of the worker's hand wherever it moves within the approach volume. If the worker's hand enters any one of several predefined zones, the worker's intent to select the part located in that zone is recorded. If the worker places his hand in a bin that does not include the correct part, the system will warn the worker by visual or auditory cues of the error, and likewise, a correct selection may be accompanied by a positive cue. In one embodiment, the system continues to monitor the worker's hand to ascertain that the correct part is removed from the rack, or in the instance that the worker first approaches the wrong part, if his hand has left the zone without picking up a part. If the worker proceeds to pick up the wrong part despite the system's warning, an error will be communicated to assembly line control devices so that appropriate corrective actions can be taken.

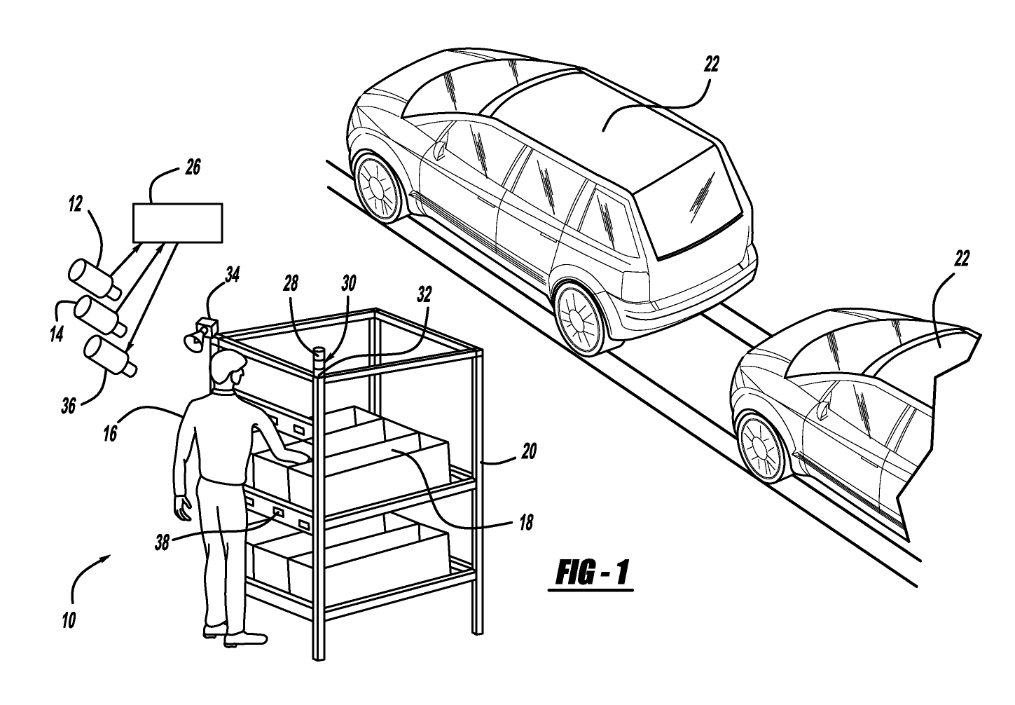

FIG. 1 is a plan view of an error detection vision system 10 of the type discussed above that employs a stereo pair of video cameras 12 and 14. In this depiction, a worker 16 is removing parts from several bins 18 positioned within a rack 20. The worker 16 will select the part from the bins 18 to be assembled on a vehicle 22 traveling down a vehicle assembly line.

The cameras 12 and 14 take video pictures of the work area around and in front of the rack 20, and provide a stream of pictures to a controller 26. The controller 26 uses known stereo vision techniques, as discussed above, to determine whether the worker 16 has placed his hand in the proper bin 18 for the particular vehicle 22 that has been detected. If the worker 16 selects the proper part, then a particular light, such as a green light 28 on a light assembly 30, can indicate that the proper part has been selected. If the worker 16 does not put his hand in the bin 18 holding the proper part, then a red light 32 on the light assembly 30 can be lit to notify the worker 16 of the mistake. Additionally, or alternately, the controller 26 can send a signal to a speaker 34 that gives an audible indication of an improper part selection.

The system 10 further includes a laser 36 that can project a low intensity laser beam towards the rack 20. A signal from the controller 26 will cause the laser 36 to direct the beam to a particular reflective piece of tape 38 adjacent to a particular one of the bins 18 when the vehicle 22 is detected on the line so that the worker 16 can receive a visual indication of which of the bins 18 he should select a part from.

Sensing of the worker's hand by stereo vision can be accomplished in several ways. When both of the cameras 12 and 14 see a common point, its three-dimensional location is easily calculated by standard triangulation formulas. The main difficulty is to identify corresponding points in the two camera images, and to determine which of these is the worker's hand. One technique is to match naturally occurring and visual features of the objects in view, such as boundaries between regions of contrasting brightness. Because the scene viewed by the camera is static except for the movement of the worker 16, taking differences between successive camera images rejects the stationary clutter, and thus helps identify the motion (velocity and position) of the worker 16. This technique, or other ways of eliminating the majority of the static scene before analyzing the remainder of the scene to detect the worker's motion, is referred to as a background decimation filter. Such a filter speeds up the frame rate of stereo distance analysis. It may be enough to monitor if any portion of the worker 16 enters the part pick-up zones, but if necessary, additional processing can be used to identify the worker's hand using a morphological model of its location at the end of the worker's arm. Higher success rates and quicker calculations can be obtained if special easily-recognized visual features are employed, such as distinctive markings on a glove worn by the worker 16. Similarly, the worker 16 may be required to wear a glove of a distinctive color so that color image processing can quickly identify the hand and locate it in three-dimensions. This would be a background decimation filter based on rejecting all colors sufficiently different from that of the glove.

An alternative to stereo vision is the use of structured-light to detect a workers hand. A simple version of structured-light is to project a plane of light, visible or infrared, and monitor it with a single camera located out of the plain directed at an angle to the plane. The camera senses the stripe of light projected onto any object that breaks the plane, thereby ascertaining where the plane has been pierced. By the use of optical filters or the like, the camera can be made sensitive to a narrow band of frequencies around that of the projected light, thus eliminating the background scene. Multiple planes of light give a three-dimensional image of an object as a collection of planar slices. Alternatively, two linear arrays of sensors placed in the plane give the location of an object in the plane by two-dimensional stereo triangulation.

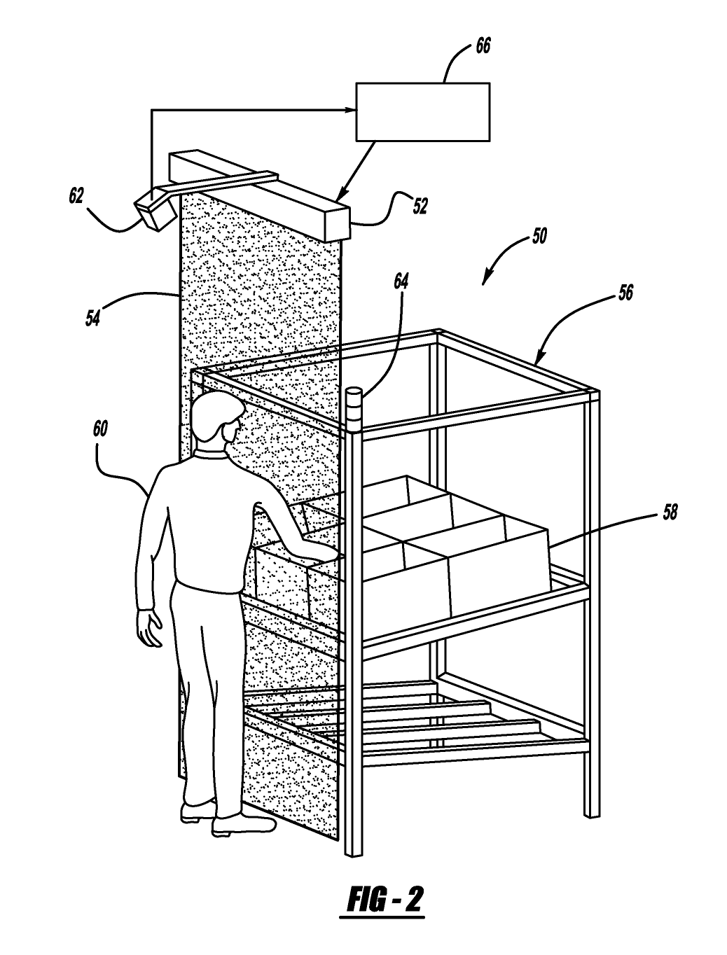

FIG. 2 is a perspective view of an error detection vision system 50 of the type discussed above using structured-light, according to another embodiment of the present invention. The system 50 includes a light source 52 projecting a planar light beam 54 in front of a rack 56. The rack 56 includes a plurality of bins 58 where each bin 58 holds a different part. When a worker 60 inserts his hand into one of the bins 58 and breaks the planar light beam 54, a camera 62 detects the location of the worker's hand by a reflection of light from the worker's arm, thus allowing the camera 62 to detect the location of the workers hand. From the reflection of the strip of light off of the workers arm, a controller 66 can use triangulation to identify the location of the workers arm, and therefore where the plane of light 54 has been broken. Thus, the system 50 can verify that the worker 60 has placed his hand in the proper bin 38 to select the proper part. The bins 38 can also be stacked on top of each other in a vertical direction.

The system 50 also includes a light assembly 64 that includes a red light and a green light for indicating that the proper part was selected, as discussed above. Further, the rack 56 can include reflective strips, such as the strips 38 positioned approximate to each bin 58, and the system 50 can include a projector, such as the laser 36, to provide a reflection from the reflective tape to identify the proper bin to the worker 60.

The technology that allows the system 50 to know where in the plane of light 54 the worker's hand is inserted can be found in virtual keyboard technology, such as from Lumio, Inc. Lumio has developed a virtual keyboard that is placed on an interface surface, such as a table, and includes a laser diode for projecting a pattern of the keyboard onto the surface. A template, such as a keyboard, is produced by illuminating a specially designed, highly efficient holographic optical element with a red diode laser. The template serves only as a reference for the user and is not involved in the detection process. In a fixed environment, the template can be printed onto the interface surface.

An infrared laser diode projects a plane of infrared illumination parallel to the interface surface just above the template. The light is invisible to the user and hovers a few millimeters above the surface. When a person's finger pierces through the planar light beam, a reflection from the worker's fingers is detected by a camera. A sensor module provides an indication of which keystroke is pressed in the projected template relative to the location that the plane of light has been broken. In other words, when the user touches a key position on the interface surface, light is reflected from this plane in the vicinity of the key position and directed towards the sensor module.

Reflected light from the interactions with the interface surface is passed through an infra-red filter and imaged onto a CMOS image sensor in the sensor module. Custom hardware embedded in the sensor module, such as the virtual interface processing core, makes a real-time determination of the location of the reflected light. A micro-controller in the sensor module receives the positional information corresponding to the light flashes from the sensor processing core, interprets the events and communicates them through an appropriate interface to external devices. The processing core can track multiple reflection events simultaneously and can support both multiple key strokes and overlapping cursor control inputs.

A third alternative for a three-dimensional vision error detecting system is to determine the time-of-flight from the emission of a short pulse of IR light to the reception of its reflection from the scene. This can be used to construct a real time range image that can detect when an object enters or exits a part pick-up zone. To increase resolution, the range image, which in current products is limited to 160×124 pixels, can be combined with the image from a conventional camera. A time-of-flight ranger can be used as the background decimation filter for a higher-resolution stereo vision system.

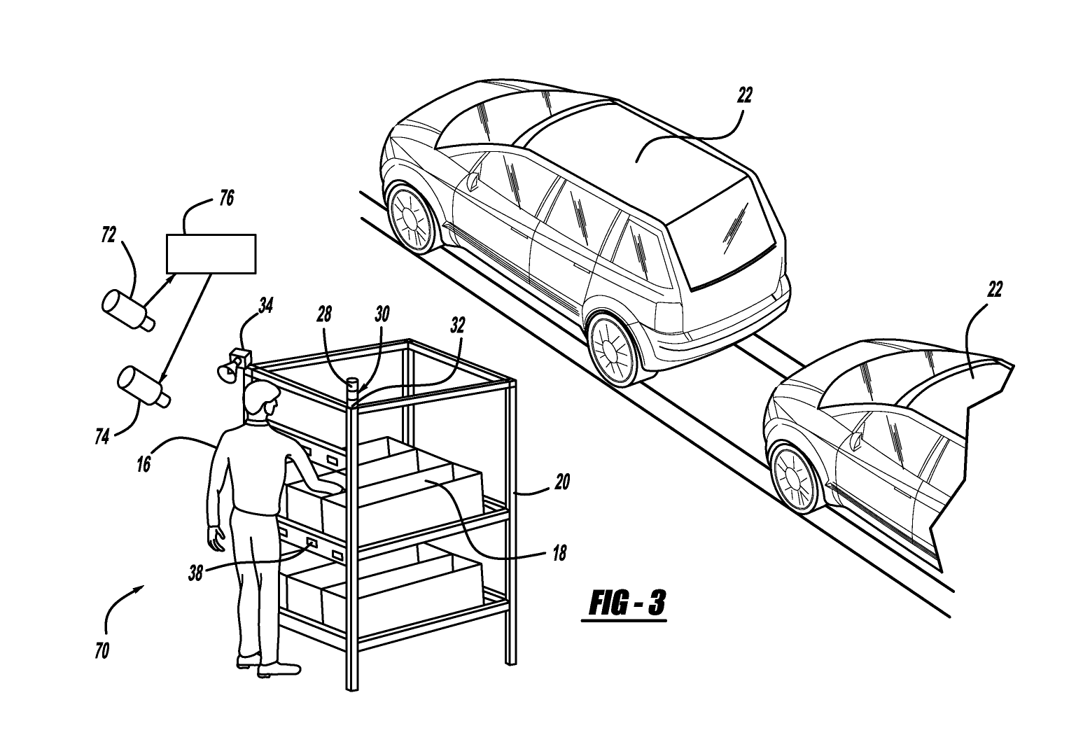

FIG. 3 is plan view of an error detection vision system 70 that employs time-of-flight emission pulses to detect a location from which a worker selects a part, according to another embodiment of present invention. The elements in the system 70 that are the same as the elements of the system 10 are identified by the same reference numeral. The system 70 includes an infrared laser 72 that emits infrared light beam pulses towards the bins 18, and reflections of the light beam pulses are received by a detector 74. Based on the time that it takes the light beam pulses to be emitted from the laser 72 and received by the detector 74 determines the location of the workers hand to know which bin 18 the worker 16 has selected a part from. A controller 76 controls the emission of pulses from the laser 72 and the images received from the detector 74, and may include a time-of-flight ranger used as a decimation filter.

It will be appreciated by those skilled in the art that a three-dimensional stereo vision system can monitor the picking of parts from an assortment of bins anywhere in the visible volume. A system using structured-light projected into a single plane is better suited primarily to racks or bins stacked in a near planar configuration.

The function of the display sub-system of the invention is mainly to show the worker which part to pick up, although it can additionally display other useful information, such as the status of the assembly in a multi-step assembly sequence or as part of the interactive set-up of the error proofing system. It is desirable to avoid hard-wired indicator lights. One of the primary advantages of the overall system is the flexibility of having remote sensing and indication capability without any physical connections to the bins. This allows the bins to be easily relocated to adjust the assembly process for ergonomics or for workload balancing between assembly stations. To provide a display compatible with this goal, the error detection vision system uses a projector to shine visible light either on the part itself or on a target adjacent to the part. The reflective properties of such a target can be chosen to enhance the effectiveness of the indicator. Several general-purpose display technologies available in the market place are suitable for this application, including DLP projectors and laser projectors. These can be interfaced to a PC-type computer to project not only indicator light markings, but also to project information text or images on a target screen located adjacent to the rack of parts. A simple laser projector sufficient for the indicator function can be constructed using an inexpensive laser diode (such as commonly used in laser pointers) in a small pan/tilt mirror.

The present invention can include a method for easily defining the part pick-up zones. One method is applicable for the case where parts are presented in bins having clear visual markings. The camera system could then automatically identify both the locations of the bins and their contents by machine vision. Lacking this, the identities of the parts can be established by putting the system in training mode and using hand gestures to outline the bin location, after which the associated part can be entered by any appropriate computer interface technology, such as typing on the keyboard, choosing from a list of parts by mouse or other pointing device, employing a bar-code reader or an RFID reader, etc. The part pick-up zones could also be identified by displaying the camera image of the rack on a computer screen and clicking on the image with a graphical interface based on a mouse or other pointing device. Since such operation is only necessary when setting up the error-detection system, such displays and interface devices might only be connected to the system during training. It should be understood that this connection might be accomplished by any one of a number of existing wired or wireless technologies, such as standard PC ports, Bluetooth wireless, etc., and could be provided by connection to a laptop or tablet PC instead of individual PC accessory devices. Web-based conductivity could also be employed.

It is intended that the camera, projection and processing elements of the invention be packaged into a compact and inexpensive module. This module could be mounted at each assembly station in a way so that it does not obstruct the operator's movement or the flexible relocation of bins and parts. The module interfaces to a master error proofing system via a device network where the module status is communicated via an array of binary bits for a more sophisticated messaging network. The messaging interface could interact with an error proofing server containing a part assignment matrix that would reference the station number, the styles and options processed in that station, and the part numbers associated with those styles. Standard logic would control basic error-proofing system operations, and line status notification with module network messages communicating two-way status of the modules confirmation of the part picked based on the requirements of assembly on the vehicle in station. The module programming function provides messages to the server that updates this part assignment matrix for that module station, providing intuitive association with parts and bins. This capability greatly increases the flexibility of the system since reprogramming the error-proofing system occurs automatically as parts and bins are moved to set-up or optimize the process.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for determining whether a correct part is selected, said system comprising:
a rack holding a plurality of bins;
a light source for projecting a plane of light in front of the rack;
a detector for detecting positions where the plane of light is broken by an object; and
a controller configured to determine whether the detected position is a desired position.

2. The system according to claim 1 wherein the plane of the light is visible light or infrared light.

3. The system according to claim 1 wherein the controller uses triangulation to determine the location where the plane of light has been broken.

4. The system according to claim 1 wherein the system determines whether a worker has selected a proper part from one of the bins, where the object that is detected by the detector is an arm or hand of the worker.

5. The system according to claim 4 further comprising a light assembly including a plurality of lights for providing a visual indication to the worker that the proper part has been selected or not been selected.

6. The system according to claim 4 further comprising a speaker for providing an audible indication that the worker has not selected the proper part.

7. The system according to claim 1 wherein the detector is a camera.

8. The system according claim 1 wherein the part is a vehicle part being assembled to a vehicle on an assembly line.

9. An error detection system for wirelessly determining whether a worker has selected a proper part to be assembled, said system comprising:
a presentation device that holds a number of different parts in different locations in the device; and
a vision sub-system for projecting one or more beams of light towards the presentation device and receiving light signals back from the presentation device indicating the location of the worker as he selects parts from the presentation device so as to determine if the proper part has been selected.

10. The system according to claim 9 wherein the vision sub-system includes a stereo pair of video cameras that take video images of the worker as the worker selects parts from the presentation device to determine the location from where the parts have been selected.

11. The system according to claim 10 wherein the vision sub-system determines the location of the worker's hand or arm by triangulation.

12. The system according to claim 10 wherein the vision sub-system employs a background decimation filter for removing background from the images received by the cameras.

13. The system according to claim 9 wherein the vision sub-system employs structured-light for detecting the location of the worker's arm or hand.

14. The system according to claim 13 wherein the vision sub-system includes a light source for projecting a planer light beam in front of the presentation device and a detector for detecting areas where the light beam is broken by the worker's arm or hand.

15. The system according to claim 14 wherein the detector is a camera.

16. The system according to claim 9 wherein the vision sub-system includes a laser for emitting light pulses towards the presentation device and a detection camera for detecting reflections from the worker, said vision sub-system using a time-of-flight analysis for determining the location of the worker's arm or hand relative to the presentation device.

17. The system according to claim 9 wherein the presentation device is a rack including a plurality of bins for holding parts.

18. The system according to claim 17 wherein the rack includes a reflective strip proximate each bin and wherein the vision sub-system includes a laser that projects a light beam to the reflective strip proximate the bin that includes the proper part to be selected.

19. The system according to claim 9 further comprising an indicator that indicates to the worker whether the worker has selected to the proper part.

20. An error detection machine vision system for wirelessly determine whether a worker has selected a proper part to be assembled, said system comprising:
a rack holding a plurality of bins, said bins holding a plurality of different parts; and
a machine vision sub-system for projecting a light beam towards the rack and receiving light reflection signals back from the rack that indicates which bin the worker has selected a part from.
